(19) United States
(12) Patent Application Publication
(10) Pub. No.: US 2017/0101523 A1
(43) Pub. Date: Apr. 13, 2017

(54) LASER-MARKABLE AND LASER-WELDABLE POLYMERIC MATERIALS

(71) Applicant: Merck Patent GmbH, Darmstadt (DE)

(72) Inventors: Reinhold RUEGER, Roedermark (DE); Ulrich QUITTMANN, Floersheim (DE)

(73) Assignee: Merck Patent GmbH, Darmstadt (DE)

(21) Appl. No.: 15/317,466

(22) PCT Filed: May 22, 2015
(86) PCT No.: PCT/EP2015/001058

§ 371 Date: Dec. 9, 2016

(30) Foreign Application Priority Data
Jun. 10, 2014 (DE) 10 2014 008 186.9

(51) Int. Cl. C08K 9/02; C09D 133/14; C09D 7/12; C08J 3/22; C09D 17/00

(52) U.S. Cl. CPC C08K 9/02; C08J 3/22; C09D 17/007; C09D 7/1266; C09D 133/14; C08K 2201/005; C08K 2201/003; C08K 2003/2231

(57) ABSTRACT

The present invention relates to laser-markable and laser-weldable polymeric materials which are distinguished by the fact that they comprise at least one fluorine-doped tin oxide (FTO) as absorber.

The present invention relates to laser-markable and laser-weldable polymeric materials which are distinguished by the fact that they comprise at least one fluorine-doped tin oxide (FTO) as absorber.

The labelling of manufactured goods is becoming increasingly important in virtually all branches of industry. Thus, for example, dates of manufacture, batch numbers, expiry dates, barcodes, 2D codes, company logos and serial numbers frequently have to be applied to plastic parts. Of increasing importance in this connection is contactless, very rapid and flexible marking using lasers. Using this technology it is possible to apply inscriptions at high spee, even to a non-planar surface. Since the inscription is located within the plastic body itself, it is permanently resistant to abrasion.

Since many plastics are transparent to laser light, laser-sensitive agents which, as a result of absorption of the laser energy in the plastic material either directly as a result of interaction with the polymer or indirectly with the added material, cause a local, highly visible discoloration, are usually added to the plastics. The laser-sensitive agent can be an organic dye or a pigment which absorbs the laser light. Various causes may be given for the discoloration, for example, the decomposition of the polymer or the absorber itself is converted from an invisible form to a visible form. A darkening in the colour of the plastic generally occurs due to carbonisation as a consequence of the laser energy introduced.

Numerous additives are known for the laser marking of plastics. Suitable materials for marking using Nd-YAG lasers (neodymium-doped yttrium aluminium garnet lasers), YVO₄ lasers (yttrium vanadate lasers) and 1064 nm fibre lasers are preferably those which absorb light of wavelength 1064 nm and themselves have only a slight intrinsic colour. Examples are copper phosphates, bismuth oxide, bismuth oxychloride, antimony-doped tin oxide on mica or metals. EP 1377522 A2 describes additives for the laser marking of plastics which consist of a calcined antimony/tin mixed oxide in which the antimony concentration at the surface is greater than that in the particles as a whole. The particle size is 0.1-10 μm, preferably 0.5-5 μm. With the additive, dark markings on pale backgrounds are obtained. However, it is not possible to obtain pale markings.

EP 1720712 A1 describes highly transparent laser-markable and laser-weldable plastic materials which comprise doped tin oxides, antimony oxides or indium oxides having a particle size of 1-100 nm and whose transparency is greater than 85% at a thickness of 2 mm and exhibit less than 3% haze 3. The markings obtained are dark.

However, dark markings can only be seen with difficulty on coloured or darkly coloured plastic parts. Examples of dark or coloured plastic parts are cable insulations, keyboards or darkly coloured plastic pipes. A pale, as far as possible white, inscription is desired here since this appears significantly higher in contrast than a grey or black marking against the dark background. Pale markings can be produced by foaming plastics by means of laser irradiation. However, this is limited to a few polymer types and leads to a considerable change in the surface as a result of the foam formation. The mechanical strength of the surface is thereby reduced.

WO 2011/085779 A1 describes materials and a process for the production of a pale laser marking. The process uses particles which consist of a white core and a preferably black or grey shell which can be decoloured by laser irradiation. The dark shell contains carbon, for example, as carbon black.

The materials described in WO 2011/085779 A1 all have the disadvantage that they are dark grey to black and therefore considerably restrict the colour design of the plastic parts. In particular, red, blue and green shades are only feasible to a limited extent, if at all.

There therefore continues to be a need for laser additives which lead, particularly on coloured or dark substrates as a result of laser bombardment, to a pale to white marking which is retained over a long period, even under mechanical stress.

It is therefore an object of the present invention to find a process for the production of high-contrast and mechanically stable markings, preferably pale markings, on coloured or dark plastic objects. A further object of the invention is the provision of an additive for the laser marking which has only a slight intrinsic colour, or none at all, and, under the action of laser light, produces very good marking results in the polymer doped therewith, in particular high-contrast and sharp pale markings on a coloured or dark background and can be used in a broad range of plastics.

It is a further object of the present invention to provide a process for the preparation of such a laser additive.

Surprisingly, it has been found that coloured or dark plastic articles can be given a pale marking by irradiation with laser light if the plastic comprises a fluorine-doped tin oxide (FTO), preferably a finely divided FTO, in a low concentration.

The invention therefore relates to a laser-markable polymeric material which is distinguished by the fact that the polymer comprises a fluorine-doped tin oxide (FTO) as absorber. With the aid of the FTO, it is possible to achieve pale and sharp-edged laser markings in dark and coloured polymers.

An electrically conductive tin oxide doped with fluorine is already known from DE 40 06 044 A1. For the action of the FTO as laser additive for a pale laser marking, the doping of tin oxide with fluorine is of particular importance. The content of fluorine in the fluorine-doped tin oxide in the present invention is preferably 1-15 mol %, in particular 3-10 mol %, based on the tin oxide.

Furthermore, the particle size can also influence the marking result. High-contrast pale markings having high edge sharpness are preferably obtained if the particle size (D₉₀) of the particles is less than 5 μm, preferably less than 2 μm. Particular preference is given to particle sizes of 1 μm. The particle size is determined in this application by means of laser diffraction (Malvern).

In the case of coloured or dark laser-markable polymers or plastics, the polymer or plastic comprises one or more colorants besides the laser additive FTO. Without a colorant, the plastic is pale and transparent to opaque. Even without colorants, pale markings are obtained in the polymer in the presence of the FTO according to the invention but these can only be seen with difficulty on account of the low contrast.

The concentration of the laser additive in the polymer, preferably thermo-plastic, thermoset or elastomer, is generally dependent on the polymer material used.

The use concentration of the FTO for pale laser marking is preferably 0.01-1%, in particular 0.05-0.5%, based on the plastic or polymer. On account of the low intrinsic colour and high transparency of FTO, the optical properties of the FTO-marked plastic or polymer are only adversely affected to a slight extent by the laser additive. The low proportion of laser additive changes the polymer system insignificantly and also does not influence its processibility.

Under the action of laser light, the FTO-doped polymer exhibits a pale marking with high contrast and pronounced edge sharpness. The foaming which occurs in other processes for pale marking and the associated roughening of the surface is not observed.

The FTO according to the invention preferably has a number-weighted particle size of <5 μm, measured at the D90 by means of laser diffraction, preferably <2 μm and particularly preferably <1 μm. The pigment particles here preferably consist of aggregates of primary particles having a diameter of less than 100 nm, preferably a diameter of less than 50 nm.

The FTO can be obtained as finely divided powder having particles sizes <5 μm as early as during production by virtue of suitable process parameters. However, it is also possible to finely grind larger particles or larger aggregates with the aid of suitable mills, for example, air-jet mills and/or bead mills. The preferred grinding process for very fine grinding is the bead mill, which enables crystalline materials and aggregates in suspension to be ground down to particle sizes of 50 nm.

The grinding is preferably carried out in aqueous suspension in the presence of one or more dispersion aids. In this way, approx. 50% aqueous suspensions of FTO are accessible. Finely divided FTO can be isolated as a powder by spray-drying or freeze-drying.

Alternatively, it is also possible to convert the finely ground pigments from the aqueous suspension into a hydrophobic preparation with the aid of suitable emulsifiers or protective colloids. The resulting hydrophobic, pasty or solid FTO preparation can then be redispersed in solvents or incorporated directly into the plastic in the form of chips.

On account of the low use concentrations of the finely divided FTO in the plastic preparations, it is advantageous for meterability firstly to prepare a highly dilute preparation of FTO. In this case, the FTO is preferably extended with an inert substance which has no intrinsic colour and is compatible with the plastics. Suitable diluents are, for example, precipitated silicas or fumed silicas or inorganic fillers, such as talc, kaolins or mica. The substances can be added before the fine grinding or afterwards.

In another advantageous embodiment, a masterbatch of the plastic having a relatively high concentration of the FTO is firstly prepared and this is then added in a small amount as granules to the main composition of the plastic during processing of the plastic.

Furthermore, colorants may be added to the polymers, allowing a broad colour variation, particularly in the colours red, green and blue. Suitable colorants are in particular organic pigments and dyes.

Suitable polymeric materials for the laser marking are, in particular, all known plastics, in particular thermoplastics, furthermore thermosets and elastomers, which are described, for example, in Ullmann, Vol. 15, p. 457 ff., Verlag VCH. Suitable thermoplastic polymers are, for example, polyethylene, polypropylene, polyamides, polyesters, polyether esters, polyphenylene ethers, polyacetal, polybutylene terephthalate (PBT), polyethylene terephthalate (PET), polymethyl methacrylate, polyvinyl acetal, polystyrene, acrylonitrile-butadiene-styrene (ABS), acrylonitrile-styrene-acrylate (ASA), styrene-acrylonitrile (SAN), polycarbonate, polyether sulfones and polyether ketones, and their copolymers, mixtures, and/or polymer blends, such as, for example, PC/ABS, MABS.

Suitable thermosetting polymers are, for example, polyurethane, melamine resins, polyesters and epoxy resins.

The incorporation of the fluorine-doped tin oxide can take place, for example, by compounding, via a masterbatch, via pastes or by direct addition during the shaping processing step (direct pigmentation). One or more additives, such as, for example, those selected from the group of processing aids, stabilisers, flame retardants, fillers and colour-imparting pigments, can optionally be added to the polymer, preferably plastic granules, during the incorporation of the absorber. The laboratory preparation of the doped plastic granules is generally carried out by initially introducing the plastic granules in a suitable mixer, wetting them with one or more dispersion aids and then adding and incorporating the absorber and the coloured pigments required. In industrial practice, the colouring of and addition of additives to the polymer is usually carried out via a colour concentrate (masterbatch) or compound. For this purpose, coloured pigments and additives are dispersed in the molten plastic with high shear in extruders (usually co-rotating twin-screw extruders). The plastic melt exits through a perforated plate on the extruder head and is converted into granules by means of suitable downstream devices (for example strand pelletising processes or underwater granulation). The granules thus obtained can be further processed directly in an extruder or injection moulding machine. The mouldings formed during the processing exhibit very homogeneous distribution of the absorber. Subsequently, the laser marking is carried out using a suitable laser.

The invention also relates to a process for the preparation of the doped polymeric materials according to the invention, characterised in that a polymeric material is mixed with the absorber and then shaped under the action of heat.

Besides the excellent optical properties, contrast and edge sharpness, the finely divided FTO allows rapid marking with high pulse rates and provides a large processing window based on the laser settings. By adjusting the laser parameters it is moreover possible to control, in a targeted manner, the paleness of the marking ranging to dark markings. Merely by controlling the laser parameters, detail-rich half-tone images are accessible. The invention likewise relates to the process of generating images.

The inscription of the polymer using the laser is carried out by bringing the specimen into the ray path of a pulsed laser, preferably an Nd:YAG laser, YVO₄ laser or 1064 nm fibre laser. Furthermore, inscription using an excimer laser, for example via a masking technique, is possible. However, the desired results can also be achieved using other conventional types of laser which have a wavelength in a region of high absorption of the pigment used. The marking obtained is determined by the irradiation time (or pulse count in the case of pulsed lasers) and irradiation power of the laser and also by the plastic system used. The power of the laser used depends on the particular application and can readily be determined by the person skilled in the art on a case by case basis.

The laser used generally has a wavelength in the range from 157 nm to 10.6 μm, preferably in the range from 532 nm to 10.6 μm. Mention may be made here, for example, of CO₂ lasers (10.6 μm) and Nd:YAG lasers (1064 or 532 nm) or pulsed UV lasers. The excimer lasers have the following wavelengths: F₂ excimer laser (157 nm), ArF excimer laser (193 nm), KrCl excimer laser (222 nm), KrF excimer laser (248 nm), XeCl excimer laser (308 nm), XeF excimer laser (351 nm), frequency-multiplied Nd:YAG lasers having wavelengths of 355 nm (frequency-tripled) or 265 nm (frequency-quadrupled). Particular preference is given to using Nd:YAG lasers (1064 or 532 nm), YVO₄ lasers, 1064 nm fibre lasers or CO₂ lasers. The energy densities of the lasers used are generally in the range from 0.3 mJ/cm² to 50 J/cm², preferably 0.3 mJ/cm² to 10 J/cm². When using pulsed lasers, the pulse frequency is generally in the range from 1 to 30 kHz. Corresponding lasers which can be used in the process according to the invention are commercially available.

The laser welding is carried out by welding a laser-transparent material to a laser-absorbing material. As laser-absorbing material, the FTO can be added in concentrations of 0.001 to 10% by weight, preferably 0.001 to 7% by weight and in particular 0.01 to 3% by weight, based on the polymer. Suitable lasers for laser welding are preferably CW diode lasers or Nd:YAG lasers at wavelengths of 800-1100 nm, preferably 808-1080 nm. The energy densities of the lasers used are generally in the range from 0.3 mJ/cm² to 200 J/cm², preferably 0.5 J/cm² to 150 J/cm².

The polymer doped in accordance with the invention can be used in all fields where conventional welding processes or printing processes have hitherto been used for the inscription or joining of plastics. For example, moulding compositions, semi-finished products and finished parts made from the polymer according to the invention can be used in the electrical, electronics and automotive industry. The labelling and inscription of, for example, cables, pipes, decorative strips or functional parts in the heating, ventilation and cooling sector or switches, plugs, levers and handles which consist of the polymer doped in accordance with the invention can be carried out with the aid of laser light even in places that are difficult to access. Furthermore, the polymer system according to the invention can be used in packaging in the food sector or in the toy sector. The markings on the packaging are distinguished by the fact that they are wipe- and scratch-resistant, stable during subsequent sterilisation processes, and can be applied in a hygienically pure manner during the marking process. Complete label images can be applied permanently to the packaging for a reusable system. Furthermore, the polymer system according to the invention is used in medical technology, for example in the marking von Petri dishes, microtitre plates, disposable syringes, ampoules, sample containers, supply tubes and medical collecting bags or storage bags.

A further important area of application for laser inscription are plastic tags for the individual labelling of animals, so-called cattle tags or ear tags. A barcode system is used to store the information which specifically belongs to the animal. This can be read off as required with the aid of a scanner. The inscription has to be very durable since the tags sometimes remain on the animals for a number of years.

The laser marking of moulding compositions, semi-finished products and finished parts which consist of the polymer according to the invention is thus possible.

The examples below are intended to explain the invention, but without limiting it. The percentages indicated are percent by weight.

### EXAMPLES

### Example 1

A powder mixture of 47.5 g of anhydrous tin(II) chloride, 22 g of sodium carbonate (anhydrous), 5 g of sodium fluoride and 43 g of sodium chloride are dry-ground in a ball mill with 3.2 kg of steel balls for 30 min. During this time, the tin(II) chloride reacts with sodium fluoride and sodium carbonate to give nanoscale fluorine-doped tin oxide. The mixture is then heated to 400° C. in a crucible, cooled and washed successively with hydrochloric acid and a number of times with water. The resulting pigment paste is dried at 110° C. and then ground to give a fine powder. The particle size of the pigment powder is determined with the aid of laser diffraction (Malvern 2000) and scanning electron microscopy. The average number-weighted particle size of the pigment particles is 560 nm, the D₉₀=1.2 μm, the size of the primary particles in the aggregates is on average 40 nm.

### Example 2

### Preparation of a Hydrophobic Finely-Divided Pigment Preparation

Fluorine-doped tin(II) oxide (FTO) from Example 1 is ground extremely finely in a bead mill with zirconium beads in a weakly acidic aqueous suspension (pH=2). The average particle size is 0.07 μm (SEM). 100 ml of the approx. 20% suspension are admixed with 15 g of polymeric protective colloid (random lauryl methacrylate-hydroxymethyl methacrylate copolymer, molar mass about 5000). The mixture is emulsified by means of ultrasound or a high-pressure homogeniser.

The solvents are stripped off in vacuo. This gives a pasty residue which consists of finely divided FTO and protective colloid. 1 g of this preparation is mixed with 5 kg of PP granules (Metocene X50081, Basell). Samples of the mixture are converted into plates having a thickness of 15 mm by injection moulding. The plastic plates have a red colour; no particles are visible using an 8× magnifying glass. Following inscription using a 12 W Nd:YAG laser (SHT at 300 mm/s and 0.03 mm beam width; 40-90% lamp energy and a frequency of 5-15 kHz), the plates exhibit a pale inscription with high contrast.

### Example 3

1 kg of PP granules (Metocene 648T, Basell) are wetted with 2 g of dispersion aid (Process-Aid 24, Colormatrix) in a drum mixer. 5 g of the pigment from Example 1 and 1 g of organic green coloured pigment (PV Fast Green GG01, Clariant) are added and incorporated for 2 min in the drum mixer. The resulting mixture is compounded in a co-rotating twin-screw extruder with high shear at a jacket temperature of 250-260° C., shaped through a pelletising die to give a strand, cooled in a water bath and granulated by means of a rotating knife. The resulting compound is dried at 100° C. for 1 h and converted into plates having the dimensions 60 mm×90 mm×1.5 mm (w×h×d) on an injection moulding machine. The plastic plates are then laser-marked using a pulsed YVO₄ laser having a wavelength of 1064 nm and a maximum output power of 10.5 W. The test grid varies the speed between 500 and 5000 mm/s and the frequency between 20 and 100 kHz.

Filled areas with a line spacing of 50 μm and also line text are lasered. Stable pale laser markings are obtained up to a speed of 3000 mm/s. The line marking is very defined with accurate detail and confirms the homogeneous distribution of the additive. No particles are visible under a 12× magnifying glass.

### Example 4 (comparison):

Preparation of Tin Oxide without Fluorine Doping

The process according to Example 1 is used to prepare finely divided tin dioxide without F doping. For this purpose, a mixture of 47.5 g of anhydrous tin(II) chloride, 31 g of sodium carbonate (anhydrous) and 43 g of sodium chloride are dry-ground in a ball mill with 3.2 kg of steel balls for 30 min. The mixture is then heated to 400° C. in a crucible, cooled and washed successively with hydrochloric acid and a number of times with water. The resulting pigment paste is dried at 110° C. and then ground to give a fine powder. The average number-weighted particle size of the pigment particles is 630 nm, the D₉₀=1.4 μm. The pigment is introduced into the plastic as described in Example 3 and converted into plates. These are exposed to the laser as described. A weak, barely visible pale marking is obtained.

### Example 5 (comparison)

### Preparation of Fluorine-Doped Tin Oxide Having Relatively Large Particles

Fluorine-doped tin oxide is prepared in accordance with Example 1 of DE 40 06 044 A1 from tin(II) oxide and tin(II) fluoride. A brownish powder is obtained which, after grinding in a bead mill, has an average number-weighted particle size of 2 μm and a D₉₀=9 μm. The resulting pigment is converted into plastic plates as described in Example 3 and exposed to the laser. This gives a dark marking that is irregular in fine elements and which, upon viewing with a 12× magnifying glass, consists of darkly marked dots. On exposure to a higher intensity, the surface becomes very roughened.

1. Laser-markable and/or laser-weldable polymers, characterised in that they comprise at least one fluorine-doped tin oxide (FTO) as absorber.

2. Laser-markable and/or laser-weldable polymers according to claim 1, characterised in that the content of fluorine in the FTO is 1-15 mol % based on the tin oxide.

3. Laser-markable and/or laser-weldable polymers according to claim 1, characterised in that the FTO has a number-weighted particle size of <5 μm, measured at the D₉₀ by means of laser diffraction.

4. Laser-markable and/or laser-weldable polymers according to claim 1, characterised in that the FTO consists of aggregates of primary particles having a diameter of less than 100 nm.

5. Laser-markable and/or laser-weldable polymers according to claim 1, characterised in that the laser additive is used in concentrations of 0.01 to 1% by weight, based on the polymer.

6. Laser-markable and/or laser-weldable polymers according to claim 1, characterised in that the polymer is a thermoplastic, thermoset or elastomer.

7. Laser-markable and/or laser-weldable polymers according to claim 1, characterised in that the polymer additionally comprises one or more coloured pigments and/or dyes.

8. Process for the preparation of laser-markable and/or laser-weldable polymers according to claim 1, characterised in that the addition of the FTO is carried out simultaneously or successively by compounding, via a masterbatch or via pastes or by direct addition to the polymer, and optionally one or more additives are added and the polymer is then shaped under the action of heat.

9. (canceled)

10. Moulding compositions, semi-finished products and finished parts consisting of the laser-markable and laser-weldable polymer according to claim 1.

11. A method of producing moulding compositions, semi-finished products or finished parts, comprising subjecting to laser energy a polymer according to claim 1.

12. A method of producing an image on an article, comprising subjecting to laser energy an article comprising a polymer according to claim 1.
